(19) United States
(12) Patent Application Publication
(10) Pub. No.: US 2018/0235403 A1
(43) Pub. Date: Aug. 23, 2018

(54) TITANIUM ELECTRIC FRYING PAN

(71) Applicant: Justin LeBlanc, Westlock (CA)

(72) Inventor: Justin LeBlanc, Westlock (CA)

(21) Appl. No.: 15/894,837

(22) Filed: Feb. 12, 2018

Related U.S. Application Data
(60) Provisional application No. 62/433,225, filed on Dec. 12, 2016.

(51) Int. Cl. A47J 37/10; A47J 36/02

(52) U.S. Cl. CPC A47J 37/105; A47J 36/02

(57) ABSTRACT

A cookware which may have a titanium pan bottom that has been bisected by a thermal partition into two independent cooking sections. The thermal partition is configured to thermally insulate a first cooking portion and a second cooking portion from each other. A sidewall and the pan bottom together forming a cooking cavity. A lid is configured to close the cooking cavity. A first heating element is coupled to the base and thermally coupled to the first cooking portion of the pan bottom. A second heating element is coupled to the base and thermally coupled to the second cooking portion of the pan bottom. A removably attached user interface is in communication with a heating controller and configured to set a first cooking temperature and a second cooking temperature, independently of each other. The cookware further features a removably attached temperature gage.

### CROSS REFERENCE TO RELATED APPLICATION

The present application is related to and claims priority to U.S. Provisional Patent Application No. 62,433,225 filed Dec. 12, 2016, which is incorporated by reference herein in its entirety.

### BACKGROUND OF THE INVENTION

The following includes information that may be useful in understanding the present disclosure. It is not an admission that any of the information provided herein is prior art nor material to the presently described or claimed inventions, nor that any publication or document that is specifically or implicitly referenced is prior art.

### 1. Field of the Invention

The present invention relates generally to the field of cookware and more specifically relates to electric frying pans.

### 2. Description of Related Art

Existing cookware comprises of materials that may give off unwanted byproducts when used. Nonstick coatings deteriorate slowly after many uses and discharge toxic substances into food. These toxic fumes and chemicals can build up in the bodies of a user and have detrimental impacts on health and wellbeing. Polytetrafluoroethylene, a synthetic fluoropolymer of tetrafluoroethylene, also known as PTFE, is a common substance used to dispose on cookware for its nonstick properties. PTFE is nontoxic at lower temperatures, however at higher temperatures PTFE decomposes. The degradation by-products have proved to be lethal to animals and cause flu-like symptoms in humans, known as “polymer fume fever”.

Many people choose to avoid microwaves due to their ability to decompose phytochemicals and vitamins, thereby neutralizing any health benefits of eating produce. These health-conscious people rely on using pots, pans, and other thermally inductive cookware to prepare meals. Often, multiple cookware must be utilized for preparing various food items at different temperatures. Existing cookware may be laden with unwanted additive coatings and may further be burdensome to hand wash in a sink due to the multitude of non-water-resistant components. A suitable solution is desired.

U.S. Pat. No. 6,369,366 to Charles F. Mullen relates to a portable dc and ac electric cooking apparatus. The described portable dc and ac electric cooking apparatus includes A combination electric cooking apparatus capable of being selectively operated by either a D.C. or A.C. electrical power source for cooking a variety of foods. The apparatus includes a pair of hinged pan-shaped housing members which can be pivoted between a closed position superposed one above the other in opposed facing relation and an open position laterally adjacent one another. A heating plate is carried by each housing member and each plate has a central recessed flat surface surrounded by a raised side wall and a D.C. and an A.C. heating element secured to its underside, each heating element individually controlled by a separate thermostat. In the closed position, the recessed flat surfaces and raised side walls form a central cavity. In the open position, the recessed flat surface and side wall of each plate serve as a mounting surface to receive cooking vessels having mating bottoms. D.C. power may be supplied by an auxiliary battery, a vehicle battery, or a battery charger. Another aspect of the invention is a D.C. electric cooking system for vehicles and boats which are provided with an auxiliary heavy duty D.C. electrical circuit and receptacle for powering the cooker and other high wattage D.C. appliances.

### BRIEF SUMMARY OF THE INVENTION

In view of the foregoing disadvantages inherent in the known cookware art, the present disclosure provides a novel electric frying pan apparatus. The general purpose of the present disclosure, which will be described subsequently in greater detail, is to provide an efficient cookware system.

A cookware is disclosed herein. The cookware includes a base configured to elevate support the electric frying pan on the horizontal surface. A pan bottom is coupled to the base, the pan bottom may include: a first cooking portion preferably made of a non-ferrous material; a second cooking portion preferably made of the non-ferrous material, and a thermal partition interspersed between the first cooking portion and the second cooking portion. The thermal partition is configured to thermally insulate the first cooking portion and the second cooking portion from each other. The first cooking portion, the thermal partition, and the second cooking portion form a continuous horizontal surface configured for cooking. A sidewall is coupled to and extending upward from the pan bottom. The sidewall may have a sidewall height measured upward from the pan bottom. The sidewall forms a continuous, upwardly-pointing barrier circumscribing the pan bottom, the sidewall and the pan bottom together forming a cooking cavity capable of retaining a liquid within the cooking cavity. A lid is configured to close the cooking cavity.

A first heating element is coupled to the base and thermally coupled to the first cooking portion of the pan bottom. A second heating element is coupled to the base and thermally coupled to the second cooking portion of the pan bottom. A power supply is electrically coupled to the first heating element and the second heating element. A heating controller is in electrical communication with the power supply, the first heating element, and the second heating element. The heating controller is configured to power the first heating element and the second heating element via the power supply. The heating controller is further configured to independently operate the first heating element at a first cooking temperature and the second heating element at a second cooking temperature as desired. A user interface is in communication with the heating controller and configured to set the first cooking temperature and the second cooking temperature, independently of each other.

For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and methods of use for the present disclosure, an electric frying pan apparatus, constructed and operative according to the teachings of the present disclosure.

FIG. 1 is a front perspective view of the cookware during an ‘in-use’ condition, according to an embodiment of the disclosure.

FIG. 2 is a top perspective view of the cookware of FIG. 1, according to an embodiment of the present disclosure.

FIG. 3 is a top perspective view of the cookware of FIG. 1, according to an embodiment of the present disclosure.

FIG. 4 is a top perspective view of the cookware of FIG. 1, according to an embodiment of the present disclosure

The various embodiments of the present invention will hereinafter be described in conjunction with the appended drawings, wherein like designations denote like elements.

### DETAILED DESCRIPTION

As discussed above, embodiments of the present disclosure relate to cookware and more particularly to an electric frying pan apparatus as used to improve efficiency in cooking

Generally, the cookware has a 12″×24″ cooking surface with a dual burner temperature control, which will allow two foods to be cooked in the same pan at the same time but at different temperatures. The heated surface of the pan may be made of titanium and non-coated such that the pan does not leach any by-products. There is an insulated strip between the two halves to ensure the correct temperature is maintained on each side. It has a stainless-steel lid with a detachable temperature monitor. Both the temperature monitor and the handle can be removed for easy cleaning. The temperature burner control may also be detached, so the pan may be washed without damaging it. There may be a plastic bracket at the back of the pan, which may be used as a stand for the lid to rest while the food cooks uncovered. The handle for the lid may be located at the back to help support the lid when it is resting in the bracket. Vents on the lid may be opened to release steam when cooking with the lid closed over the contents in the pan. The disclosed frying pan may be powered with a detachable cord plugged into an outlet in the kitchen or whenever the pan is being used for cooking. A solar panel attachment or alternative energy source may be designed, so this pan can be used without needing to be connected to an electric outlet. It could then be used when camping, tailgating, and on many other occasions. A smaller version, measuring 12″×12″ may also be available as well as a stainless-steel leg attachment.

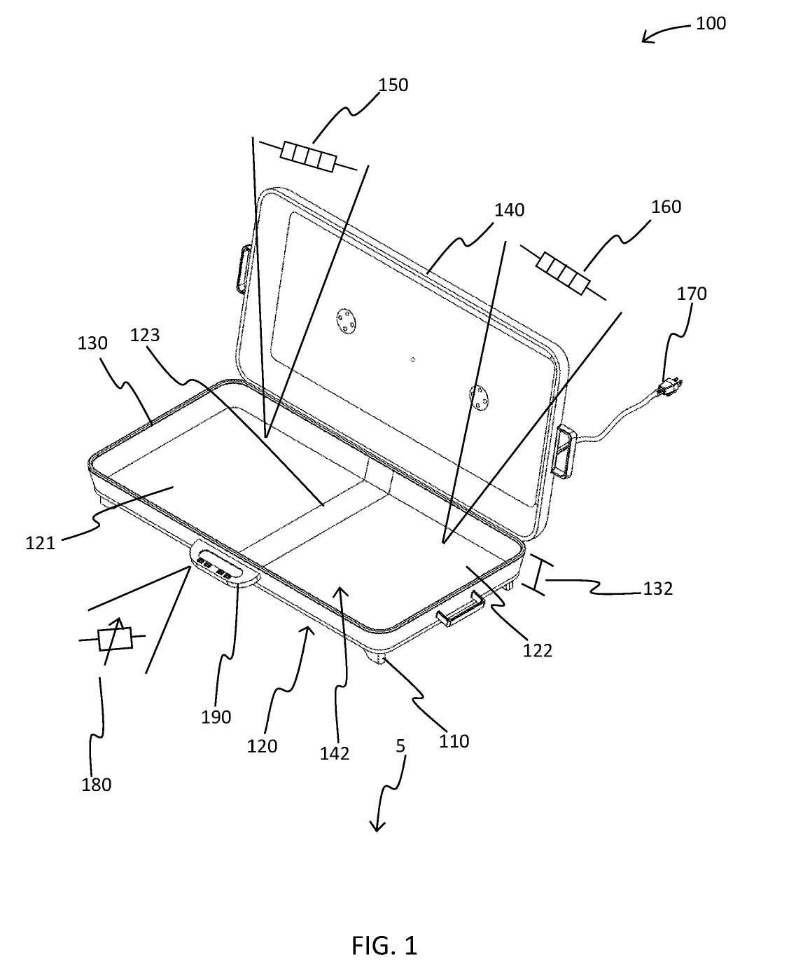

Referring now more specifically to the drawings by numerals of reference, there is shown in FIGS. 1-4, various views of cookware 100. FIG. 1 shows a cookware 100 during an ‘in-use’ condition 150, according to an embodiment of the present disclosure. As Illustrated, the cookware 100 may include a base 110 configured to elevate support the electric frying pan 100 on the horizontal surface 5. A pan-bottom 120 is coupled to the base, the pan-bottom 120 may include a first-cooking-portion 121 made of a non-ferrous material, a second-cooking-portion 122 made of the non-ferrous material, and a thermal-partition 123 interspersed between the first-cooking-portion 121 and the second-cooking-portion 122 and configured to thermally insulate the first-cooking-portion 121 and the second-cooking-portion 121 from each other. The first-cooking-portion 121, the thermal-partition 123, and the second-cooking-portion 122 form a continuous horizontal surface configured for cooking.

A sidewall 130 is coupled to, and extends upward from the pan-bottom 120, the sidewall 130 may have a sidewall height 132 measured upward from the pan-bottom 120, the sidewall 130 forms a continuous, upwardly-pointing barrier circumscribing the pan-bottom 120. The sidewall 130 and the pan-bottom 120 together form a cooking cavity 142 capable of retaining a liquid within the cooking cavity 142, up to the sidewall height 132. A lid 140 is configured to close the cooking cavity 142.

A first-heating-element 150 is coupled to the base 110 and thermally coupled to the first-cooking-portion 121 of the pan-bottom 120. A second-heating-element 160 is coupled to the base 130 and thermally coupled to the second-cooking-portion 122 of the pan-bottom 120. A power-supply 170 is electrically coupled to the first-heating-element 150 and the second-heating-element 160. A heating controller 180 is in electrical communication with the power supply 170, the first-heating-element 150, and the second-heating element 160. The heating control 180 is configured to power the first-heating-element 150 and the second-heating-element 160 via the power supply 170, and further configured to independently operate the first-heating-element 150 at a first-cooking-temperature and the second-heating-element 160 at a second-cooking-temperature. A user interface 190 is in communication with the heating controller 180 and configured to set the first-cooking-temperature and the second-cooking-temperature, independently of each other.

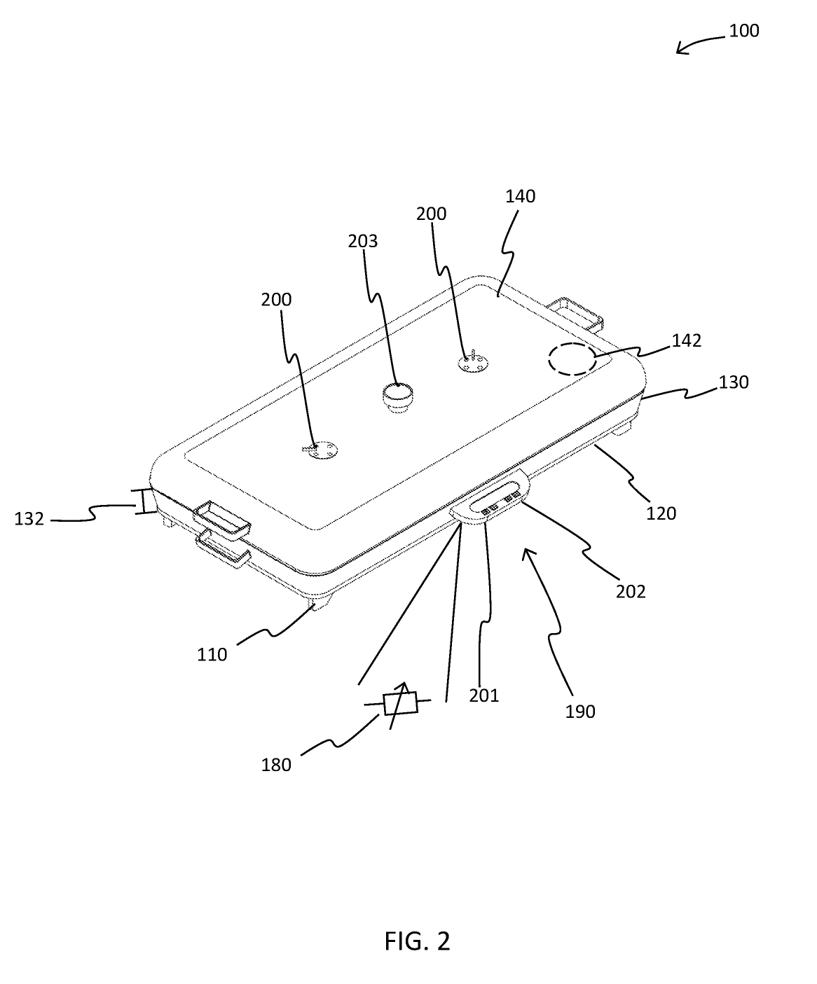

FIG. 2 shows a front perspective view of the cookware 100 of FIG. 1, according to an embodiment of the present disclosure. As above, the cookware 100 may include a pan-bottom 120 coupled to the base 110. A sidewall 130 is coupled to and extending upward from the pan-bottom 120, the sidewall 130 having a sidewall height 132 measured upward from the pan-bottom 120, the sidewall 130 forming a continuous, upwardly-pointing barrier circumscribing the pan-bottom 120; the sidewall and the pan-bottom 120 together forming a cooking cavity 142 capable of retaining a liquid within the cooking cavity 142, up to the sidewall height 132.

A user interface 190 is in communication with the heating controller 180. The user interface 190 further includes a first-temperature-control 201 and a second-temperature-control 202. The first-temperature-control 201 and the second-temperature-control 202 are configured to independently control temperatures on respective sides of the pan-bottom 120. The first-temperature-control 201 and the second-temperature-control 202 may be separable from the cookware 100.

A lid 140 is configured to close the cooking cavity 142. They lid 140 may include a plurality of apertures 200 configured to vent heated gasses from within the cooking cavity 142, when the cooking cavity 142 is closed. The lid 140 may be made of a stainless-steel material. The lid 140 may further include a temperature gage 203 configured to read the mean temperature within the cooking cavity 142. The temperature gage 203 is removably attachable to lid 140 of the cookware 100.

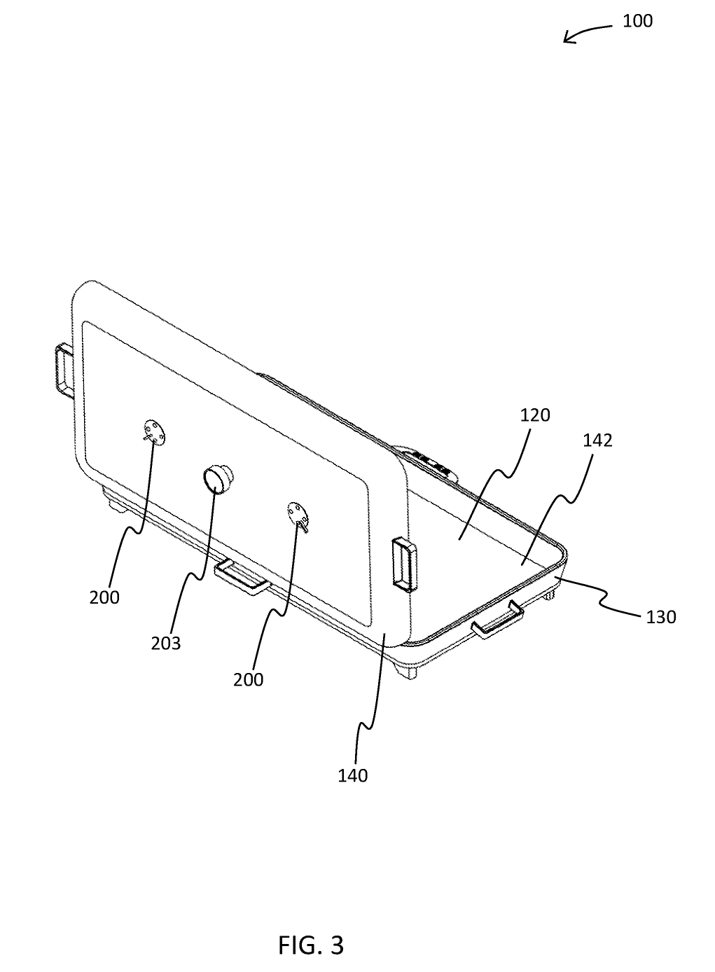

Referring now to FIG. 3 showing a rear perspective view of the cookware 100 of FIG. 1, according to an embodiment of the present disclosure. As above, the cookware 100 may include a lid 140 that features a plurality of apertures 200 configured to vent heated gasses from within the cooking cavity 142 when the cooking cavity 142 is closed. The lid 140 may be made of a stainless-steel material and may have corresponding dimensions to the pan-bottom 120 and the sidewall 130. The dimensions of the lid 140 may be 12-inches by 24-inches. As illustrated, the lid may further comprise a temperature gage 203 that is configured to read the mean temperature from within the cooking cavity 142.

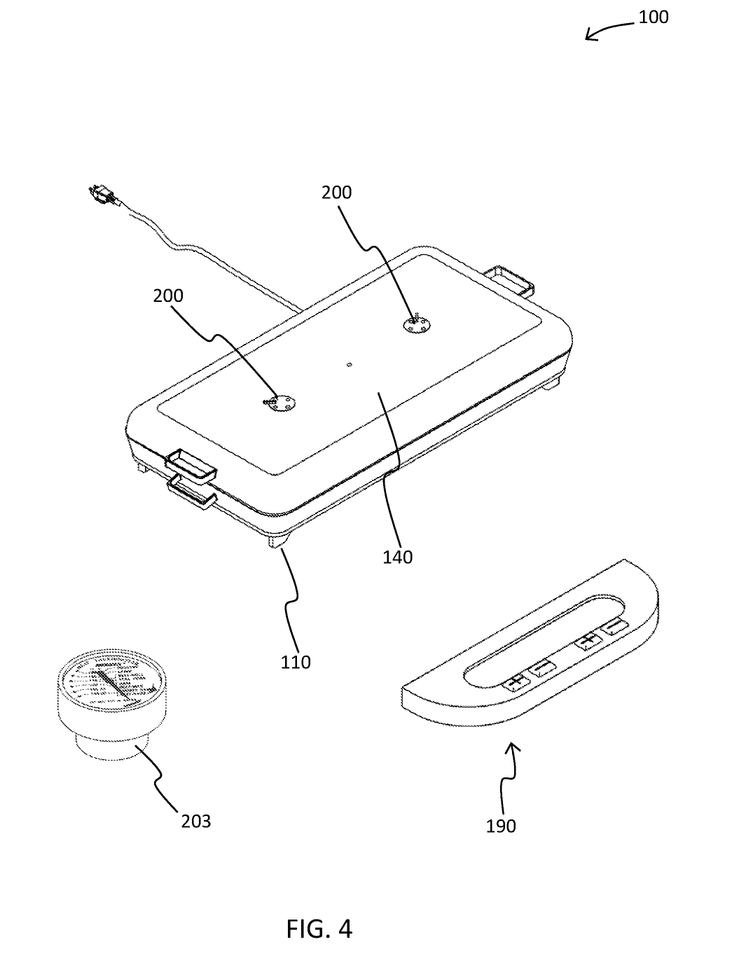

FIG. 4 shows a front perspective view of the cookware 100 of FIG. 1, according to an embodiment of the present disclosure. In the present embodiment, the cookware 100 is illustrated with the removably attached features separated from the main body of the cookware 100. Here shown is the lid 140 having a plurality of apertures 200 with the temperature gage 203 detached and separated. The user interface 190 have been detached and removed from the base 110 of the cookware 100. In yet another embodiment, the base 110 may be detached and separated from the cookware 100. The intent of the removable components is to allow the independent components of the cookware 100 to be washed easily.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is new and desired to be protected by Letters Patent is set forth in the appended claims:

1. An electric frying pan for a top of a horizontal surface, the frying pan comprising:
a base configured to elevate support the electric frying pan on the horizontal surface;
a pan-bottom coupled to the base, the pan-bottom including a first-cooking-portion made of a non-ferrous material, a second-cooking-portion made of the non-ferrous material, and a thermal-partition interspersed between the first-cooking-portion and the second-cooking-portion, and configured to thermally insulate the first-cooking-portion and the second-cooking-portion from each other, the first-cooking-portion, the thermal-partition, and the second-cooking-portion forming a continuous horizontal surface configured for cooking;
a sidewall coupled to and extending upward from the pan-bottom, the sidewall having a sidewall height measured upward from the pan-bottom, the sidewall forming a continuous, upwardly-pointing barrier circumscribing the pan-bottom, the sidewall and the pan-bottom together forming a cooking cavity capable of retaining a liquid within the cooking cavity, up to the sidewall height;
a lid configured to close the cooking cavity;
a first-heating-element coupled to the base and thermally coupled to the first-cooking-portion of the pan-bottom;
a second-heating-element coupled to the base and thermally coupled to the second-cooking-portion of the pan-bottom;
a power-supply electrically coupled to the first-heating-element and the second-heating-element;
a heating controller in electrical communication with the power supply, the first-heating-element, and the second-heating element, the heating control configured to power the first-heating-element and the second-heating-element via the power supply, and further configured to independently operate the first-heating-element at a first-cooking-temperature and the second-heating-element at a second-cooking-temperature; and
a user interface in communication with the heating controller, and configured to set the first-cooking-temperature and the second-cooking-temperature, independently of each other.

2. The electric frying pan of claim 1, wherein the non-ferrous material is titanium, and alternatively, an alloy thereof.

3. The electric frying pan of claim 1, wherein the user interface further includes a first-temperature-control and a second-temperature-control.

4. The electric frying pan of claim 3, wherein the first-temperature-control and the second-temperature-control are configured to set the first-cooking-temperature and the second-cooking-temperature respectively.

5. The electric frying pan of claim 3, wherein the first-temperature-control and the second-temperature-control are separable from the frying pan.

6. The electric frying pan of claim 1, wherein the thermal-partition is made of a ceramic material.

7. The electric frying pan of claim 1, wherein the lid includes a plurality of apertures configured to vent heated gasses from within the cooking cavity, when said cooking cavity is closed.

8. The electric frying pan of claim 1, wherein the lid is made of a stainless steel.

9. The electric frying pan of claim 1, wherein the non-ferrous material has a machine finish configured to provide a smooth surface.

10. The electric frying pan of claim 1, wherein the non-ferrous material has a bare finish.

11. The electric frying pan of claim 1, further comprising a temperature gage configured to read the mean temperature within the cooking cavity.

12. The electric frying pan of claim 11, wherein the temperature gage is removably attachable to lid of the electric frying pan apparatus.

13. The electric frying pan of claim 1, wherein the base is removable and completely separable.

14. The electric frying pan of claim 1, wherein the electric frying pan has dimensions of 12-inches by 24-inches.

15. The electric frying pan of claim 1, wherein the lid is removable and completely separable.
